(19) United States
(12) Patent Application Publication
(10) Pub. No.: US 2014/0209191 A1
(43) Pub. Date: Jul. 31, 2014

(54) AIRTIGHT GASKET FOR PNEUMATIC TOOL

(71) Applicant: SUNMATCH INDUSTRIAL CO., LTD., Zhubei City (TW)

(72) Inventor: Lung-Pao CHEN, Zhubei City (TW)

(73) Assignee: SUNMATCH INDUSTRIAL CO., LTD, Zhubei City (TW)

(21) Appl. No.: 14/013,400

(22) Filed: Aug. 29, 2013

(30) Foreign Application Priority Data
Jan. 28, 2013 (TW) 102201802

(51) Int. Cl. F16J 15/06

(52) U.S. Cl. CPC F16J 15/06
USPC 137/455

(57) ABSTRACT

An airtight gasket for a pneumatic tool including an airflow regulation portion, an air intake passage to direct high pressure air into the airflow regulation portion and a pneumatic motor to receive the high pressure air from the airflow regulation portion and generate spinning. The airflow regulation portion includes a regulation valve which contains a flow directing vent corresponding to the air intake passage and a recess surrounding the flow directing vent. The airtight to gasket is clamped between the regulation valve and air intake passage, and includes a base located in the recess, a through-hole located on the base to channel the high pressure air into the flow directing vent, and an airtight convex ring surrounded the through-hole and extended integrally from the base towards to air intake passage.

### FIELD OF THE INVENTION

The present invention relates to an airtight gasket for pneumatic tool and particularly to an airtight gasket that has an extended airtight convex ring to enhance airtight efficacy with an air intake passage.

### BACKGROUND OF THE INVENTION

A conventional pneumatic tool such as one disclosed in R.O.C. patent 1252796 employs high pressure air as a driving source to drive a spindle of a pneumatic motor to spin and a drilling tool coupled on the spindle to perform drilling operation.

Moreover, the general pneumatic tool has a high pressure airflow path, such as that disclosed in R.O.C. patent M262329, that includes an air intake passage formed on a housing to receive the high pressure air which passes through an airflow regulation element to change airflow direction, then the high pressure air enters an air chamber to drive a pneumatic motor to spin. In order to ensure that the high pressure air can flow according to the designed airflow path after entering the pneumatic tool without generating air leakage, the pneumatic tool generally adopts an airtight design. The pneumatic tool generally consists of a plurality of elements coupled together. The structural sets also are bridged by an airtight gasket via clamping on the airflow path to confine airflow direction of the high pressure air during passing through the junction of two neighboring structural sets and achieve airtight effect. The general airtight gasket generates the airtight effect by merely compressing two neighboring structural sets. In other words, the airtight efficacy is determined by the compression degree of the two neighboring structural sets. Air leakage could still take place. R.O.C. patent 1363835 discloses an airtight ring for an air cylinder head to achieve air tight effect between structural sets. Its airtight ring is formed in an inclined manner and has to be designed and fabricated accurately according to the shape of the air port. Hence precise machining is required and fabrication is more difficult. Moreover, the conventional airtight ring forms a plane contact between elements that has a greater contact area and results in deficient compression. To overcome the aforesaid drawbacks and facilitate assembly more precise design of element dimensions is needed. All this makes production cost higher.

### SUMMARY OF THE INVENTION

The primary object of the present invention is to provide an airtight gasket with an extended airtight convex ring to increase airtight efficacy with an airflow regulation portion.

To achieve the foregoing object the present invention provides an airtight gasket for a pneumatic tool including an air intake passage to direct high pressure air into the airflow regulation portion and a pneumatic motor. to receive the high pressure air from the airflow regulation portion and generate spinning. The airflow regulation portion includes a regulation valve which contains a flow directing vent opened to the airflow passage to receive the high pressure air and a recess surrounding the flow directing vent. The airtight gasket is clamped between the regulation valve and air intake passage, and includes a base located in the recess, a through-hole formed on the base and communicated with the air intake passage and flow directing vent to receive the high pressure airflow, and an airtight convex ring surrounded the through-hole and extended integrally from the base towards to air intake passage.

In one embodiment the airtight convex ring surrounds and covers a scope greater at least than the inner diameter of the air intake passage.

In another embodiment the airtight convex ring surrounds and covers a scope which is formed in a geometric shape.

In yet anther embodiment the airtight gasket further includes a retaining wall extended from the through-hole to the regulation valve and in contact with the inner rim of the flow directing vent.

In yet another embodiment the airtight gasket is made from a flexible material which can be rubber.

In yet another embodiment the regulation valve includes an assembly element which contains the flow directing vent and recess and is anchored on the pneumatic tool, and a rotary valve ring located on the assembly element and turnable to change the direction of the high pressure air.

The airtight gasket, compared with the conventional structure, achieves secured airtight effect between the air intake passage and regulation valve. With the airtight gasket clamped between the air intake passage and regulation valve, it can be compressed and deformed to attain desired air tight efficacy. Moreover, the airtight convex ring on the airtight gasket can further enhance the air tight efficacy to accomplish airtight effect of the pneumatic tool during directing the high pressure air. Compared with plane sealing structure of the conventional airtight gasket the airtight gasket of the invention has an extended airtight convex ring from the base towards the air intake passage, and the airtight convex rings is formed at a width smaller than the area of the base, hence provides improved compressibility to tightly seal the gap between the structural elements and facilitate assembly of the pneumatic tool.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the airtight gasket of the invention implemented on a pneumatic tool.

FIG. 2 is an exploded view of the airtight gasket of the invention implemented on a pneumatic tool, viewed from another direction.

FIG. 3 is a sectional view of the airtight gasket of the invention implemented on a pneumatic tool.

FIG. 4 is a fragmentary enlarged cross section of the airtight gasket of the invention implemented on a pneumatic. tool.

### DETAILED DESCRIPTION OF THE PREFERRED EMBODIMENT

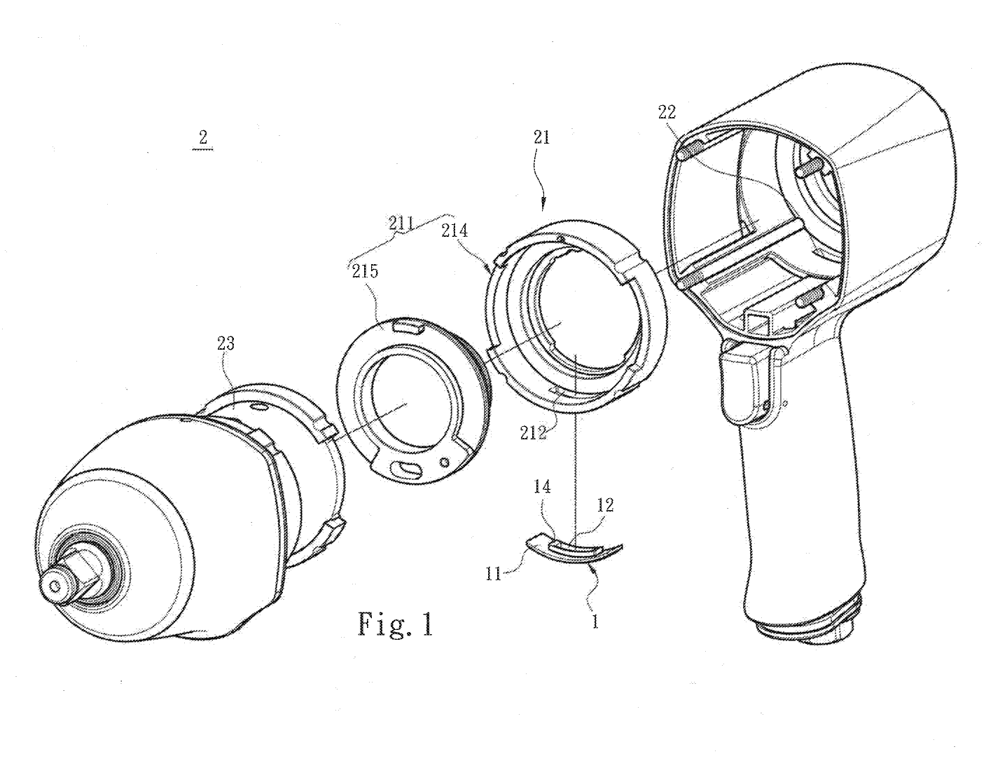

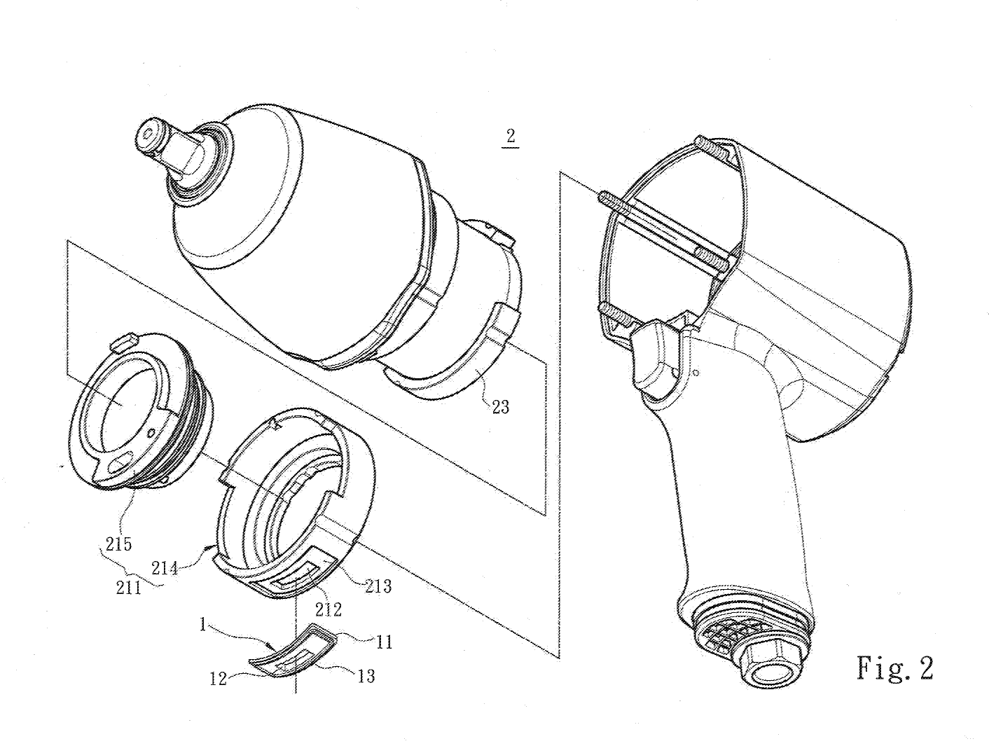

Please referring to FIGS. 1 and 2, the present invention aims to provide an airtight gasket 1 installed on a pneumatic tool 2. The pneumatic tool 2 employs high pressure air as a driving source to do operation of striking or drilling. The pneumatic tool 2 includes an airflow regulation portion 21, an air intake passage 22 to direct the high pressure air into the airflow regulation portion 21 and a pneumatic motor 23 to receive the high pressure air from the airflow regulation portion 21 to generate spinning. The airflow regulation portion 21 mainly includes a regulation valve 211 corresponding to the air intake passage 22 and containing a flow directing vent 212 opened to the airflow passage 22 and a recess 213 surrounding the flow directing vent 212. The flow directing vent 212 communicates with the air intake passage 22 and airflow regulation valve 211 to direct the high pressure air in the air intake passage 22 to pass through the flow directing vent 212 to enter the regulation valve 211. More specifically, the regulation valve 211 further has an assembly element 214 to contain the flow directing vent 212 and recess 213 and anchor on the pneumatic tool 2, and a rotary valve ring 215 mounted onto the assembly element 214 and turnable thereon for a selected angle to harness and change the flow direction of the high pressure air channeled from the air intake passage 22 into the regulation valve 211.

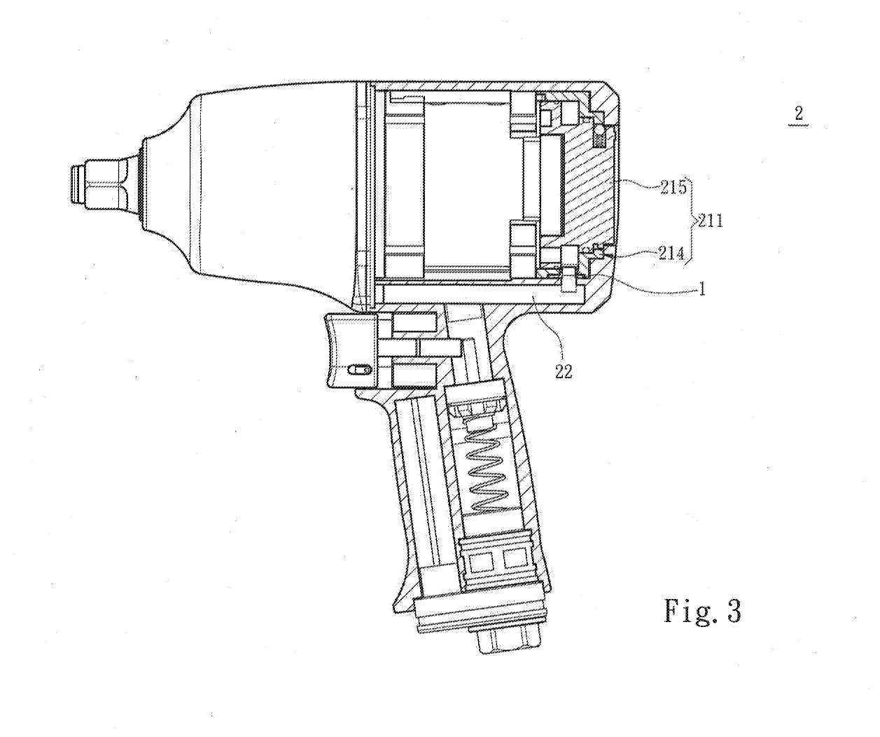

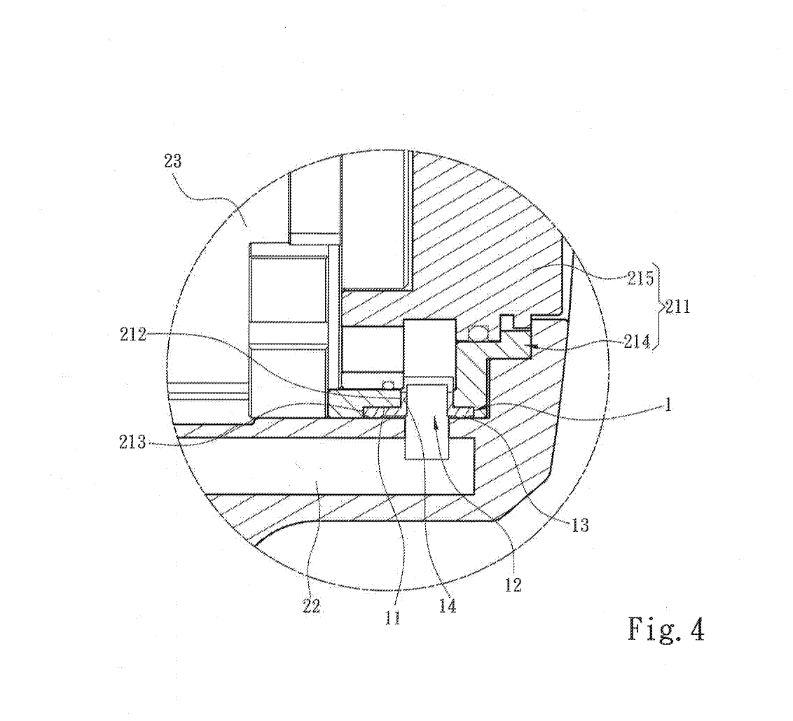

Also referring to FIGS. 3 and 4, the airtight gasket 1 is clamped between the regulation valve 211 and air intake passage 22, and includes a base 11 located in the recess 213, a through-hole 12 formed on the base 11 and connected to the air intake passage 22 and flow directing vent 212, and an airtight convex ring 13 extended integrally from the base 11 towards the air intake passage 22 and surrounded the through-hole 12. More specifically, the airtight gasket 1 can be made from a flexible material such as rubber. The base 11, through-hole 12 and airtight convex ring 13 are integrally formed. When the airtight gasket 1 is clamped by the regulation valve 211 and air intake passage 22, it slightly deforms and extended to the airtight convex ring 13 so that the airtight passage 22 and regulation valve 211 are coupled tightly, thereby confine the high pressure air to pass through merely through the airflow passage 12 to the regulation valve 211. Furthermore, the airtight convex ring 13 can be formed on the base 11 by surrounding a scope in a selected geometric shape, such as a circle or square. Also referring to FIGS. 1 and 4, aside from the structure previously discussed, the airtight gasket 1 can further includes a retaining wall 14 extended from the airflow passage 12 to the regulation valve 211 in contact with the inner rim of the flow directing vent 212. The retaining wall 14 provides position confining during assembly and can be integrally formed with the base 11 to further enhance airtight efficacy.

As a conclusion, the airtight gasket for pneumatic tools of the invention is clamped between the air intake passage and regulation valve to generate deformation and create initial air tight effect. The airtight convex ring formed on the airtight gasket further enhances the airtight effect and confines the high pressure air to pass through merely the through-hole. Moreover, the airtight convex ring is formed at a width smaller than the base, hence provides improved compressibility and maintains secured intervals between the airtight elements, thereby can overcome the problem of air leakage occurred to the conventional pneumatic tools.

While the preferred embodiment of the invention has been set forth for the purpose of disclosure, it is not the limitation of the invention, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An airtight gasket for a pneumatic tool including an airflow regulation portion, an air intake passage to direct high pressure air to enter the airflow regulation portion and a pneumatic motor to receive the high pressure air from the airflow regulation portion to spin, the airflow regulation portion including a regulation valve, the airtight gasket being clamped between the regulation valve and the air intake passage, the regulation valve including a flow directing vent opened and corresponding to the air intake passage to receive the high pressure air and a recess surrounding the flow directing vent, the airtight gasket comprising:
a base located in the recess of the regulation valve;
a through-hole formed on the base and communicated with the air intake passage and the flow directing vent to receive the high pressure air; and
an airtight convex ring surrounded the through-hole and extended integrally from the base towards the air intake passage.

2. The airtight gasket of claim 1, wherein the airtight convex ring surrounds a scope greater at least than the inner diameter of the air intake passage.

3. The airtight gasket for pneumatic tools of claim 1, wherein the airtight convex ring surrounds a scope in a selected geometric shape.

4. The airtight gasket of claim 1 including a retaining wall extended from the through-hole to the regulation valve in contact with an inner rim of the flow directing vent.

5. The airtight gasket of claim 1, wherein the airtight gasket is made from a flexible material.

6. The airtight gasket of claim 5, wherein the flexible material is rubber.

7. The airtight gasket of claim 1, wherein the regulation valve includes an assembly element to contain the flow directing vent and the recess and anchor on the pneumatic tool, and a rotary valve ring located on the assembly element and turnable to change the direction of the high pressure air.
